(19) United States
(12) Patent Application Publication
(10) Pub. No.: US 2017/0255340 A1
(43) Pub. Date: Sep. 7, 2017

(54) INFORMATION PROCESSING APPARATUS, AND CONTROL METHOD AND CONTROL PROGRAM THEREOF

(71) Applicant: NEC Corporation, Tokyo (JP)

(72) Inventor: Satoru ISHII, Tokyo (JP)

(73) Assignee: NEC Corporation, Tokyo (JP)

(21) Appl. No.: 15/510,940

(22) PCT Filed: Jul. 28, 2015
(86) PCT No.: PCT/JP2015/071420

§ 371 Date: Mar. 13, 2017

(30) Foreign Application Priority Data
Sep. 16, 2014 (JP) 2014-188306

(51) Int. Cl. G06F 3/0481

(52) U.S. Cl. CPC G06F 3/0481; G09G 5/14

(57) ABSTRACT

A user-friendly information processing apparatus capable of displaying information of a new application without hiding information of an original application includes a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame, and a display controller that automatically transits to the second screen mode and arranges the second display frame and the third display frame on the screen, if the second application is called from the first application while the information generated by the first application is displayed in the first screen mode.

### TECHNICAL FIELD

The present invention relates to an information processing apparatus, and a control method and control program thereof.

### BACKGROUND ART

In the above technical field, patent literature 1 discloses a technique of activating a browser using a browser activation link in a window, and then arranging two windows side by side (see paragraph [0024]).

### CITATION LIST

### Patent Literature

Patent literature 1: International Publication No. 2012/068542

### SUMMARY OF THE INVENTION

### Technical Problem

However, the technique described in the above literature only changes window display by waiting for a user operation, which may impair user friendliness.

The present invention enables to provide a technique of solving the above-described problem.

### Solution to Problem

One aspect of the present invention provides an apparatus comprising:

a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame; and

a display controller that automatically transits to the second screen mode, arranges the second display frame and the third display frame on the screen, and displays the information generated by the first application and the information generated by the second application, if the second application is called from the first application while the information generated by the first application is displayed in the first screen mode.

Another aspect of the present invention provides a control method of an information processing apparatus including a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame, the method comprising:

automatically transiting to the second screen mode and arranging the second display frame and the third display frame on the screen, if the second application is called from the first application while the information generated by the first application is displayed in the first screen mode.

Still other aspect of the present invention provides a control program of an information processing apparatus including a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame, for causing a computer to execute a method, comprising:

automatically transiting to the second screen mode and arranging the second display frame and the third display frame on the screen, if the second application is called from the first application while the information generated by the first application is displayed in the first screen mode.

### Advantageous Effects of Invention

According to the present invention, it is possible to provide a user-friendly information processing apparatus which can display information of a new application without hiding information of an original application since a mode is automatically changed to a multi-display frame mode in response to an execution instruction of the new application.

### BRIEF DESCRIPTION OF DRAWINGS

FIG. 1 is a block diagram showing the arrangement of an information processing apparatus according to the first embodiment of the present invention;

FIG. 2A is a view showing a display example by an information processing apparatus according to the second embodiment of the present invention;

FIG. 2B is a view showing another display example by the information processing apparatus according to the second embodiment of the present invention;

FIG. 2C is a view showing still other display example by the information processing apparatus according to the second embodiment of the present invention;

FIG. 2D is a view showing still other display example by the information processing apparatus according to the second embodiment of the present invention;

FIG. 2E is a view showing still other display example by the information processing apparatus according to the second embodiment of the present invention;

FIG. 3A is a block diagram for explaining the functional arrangement of the information processing apparatus according to the second embodiment of the present invention;

FIG. 3B is a block diagram for explaining the functional arrangement of the information processing apparatus according to the second embodiment of the present invention;

FIG. 4 is a table for explaining the structure of a table used by the information processing apparatus according to the second embodiment of the present invention;

FIG. 5 is a view for explaining the structure of a table used by the information processing apparatus according to the second embodiment of the present invention;

FIG. 6 is a block diagram for explaining the hardware arrangement of the information processing apparatus according to the second embodiment of the present invention; and

FIG. 7 is a flowchart for explaining the processing procedure of the information processing apparatus according to the second embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

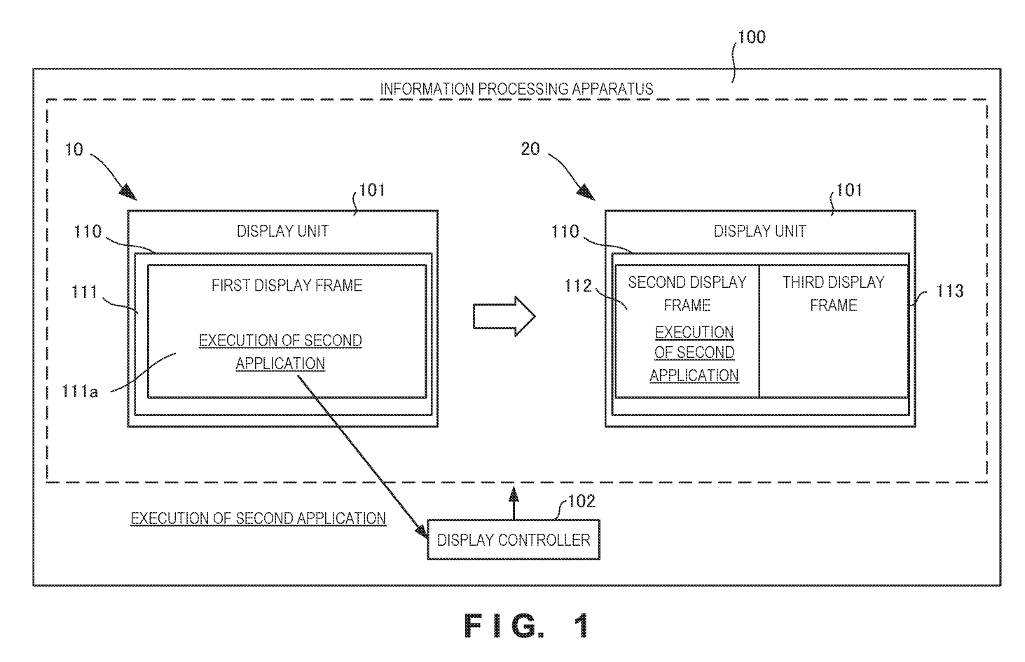

An information processing apparatus 100 according to the first embodiment of the present invention will be described with reference to FIG. 1. As shown in FIG. 1, the information processing apparatus 100 includes a display unit 101 and a display controller 102.

The display unit 101 can display a screen in a first screen mode 10 in which a first display frame 111 is arranged on the screen and information generated by the first application is displayed in the first display frame 111. On the other hand, the display unit 101 can display the screen in the second screen mode in which a second display frame 112 and a third display frame 113 are arranged on the screen, information generated by the first application is displayed in the second display frame 112, and information generated by the second application is displayed in the third display frame 113.

If the second application is called from the first application while information 111a generated by the first application is displayed in the first screen mode 10, the display controller 102 automatically transits to a second screen mode 20. Then, the second display frame 112 and the third display frame 113 are arranged on a screen 110.

Therefore, it is possible to provide a user-friendly information processing apparatus which can display information of a new application without hiding information of an original application since a mode is automatically changed to a multi-display frame mode in response to an execution instruction of the new application.

### Second Embodiment

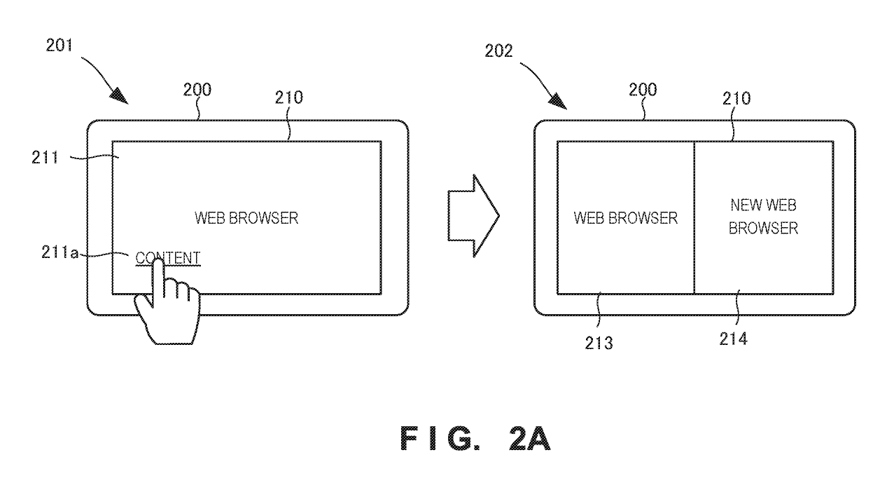

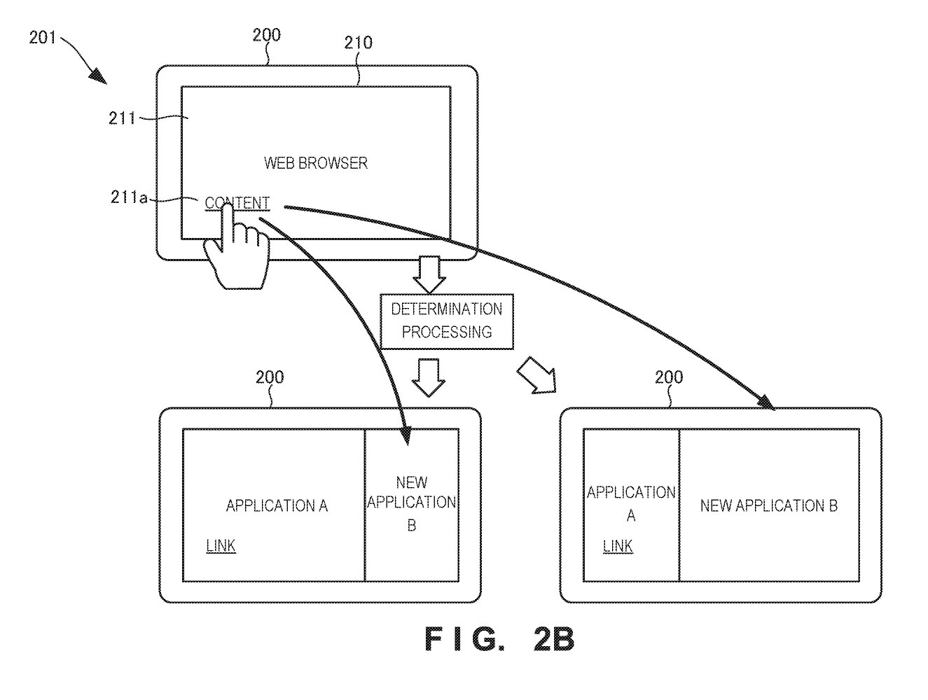

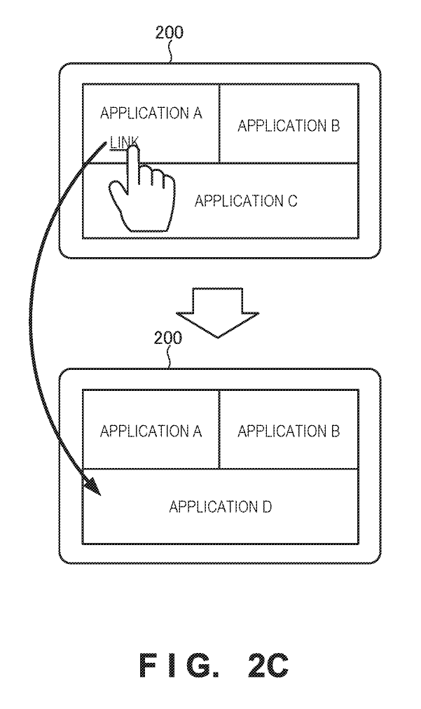

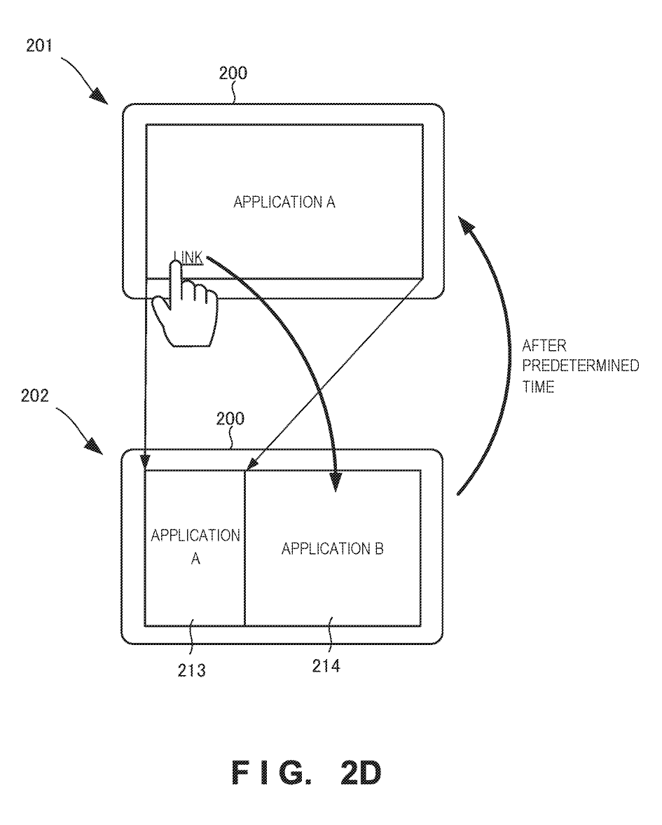

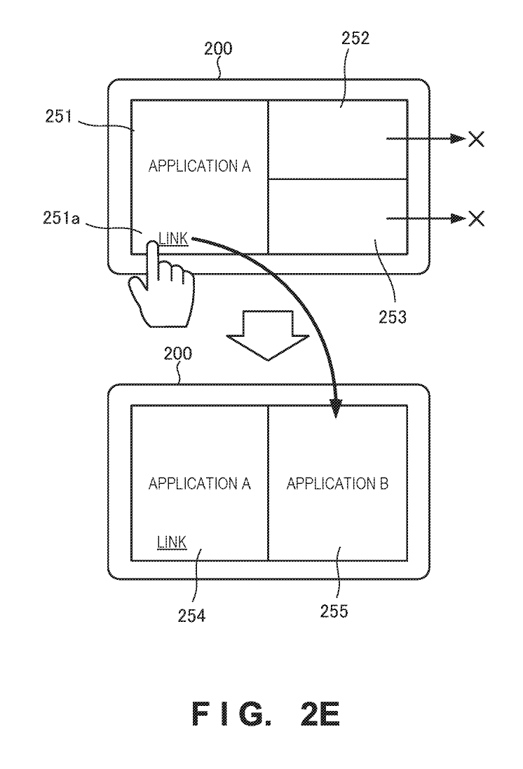

An information processing apparatus according to the second embodiment of the present invention will be described next with reference to FIG. 2A and subsequent drawings. FIGS. 2A and 2B are views for explaining screen transition of an information processing apparatus 200 according to this embodiment. The information processing apparatus 200 is an apparatus with which a display screen is integrally formed, such as a smartphone or smart device.

As shown in the right view of FIG. 2A, the information processing apparatus 200 can perform full-screen display of a display frame 211 on a screen 210 in a first screen mode 201, and displays information generated by a Web browser in the display frame 211. Furthermore, the information processing apparatus 200 can arrange display frames 213 and 214 on the screen 201 in a second screen mode 202, and display pieces of information generated by different applications in the display frames 213 and 214.

The information processing apparatus 200 displays a link 211a generated by the Web browser in the first screen mode 201. In this state, if the user performs an access (tap) operation for the link 211a, an application (in this example, a new Web browser) corresponding to the link 211a is called from a storage device in the information processing apparatus 200.

Information generated by the original Web browser is displayed in the display frame 213, and information generated by the new Web browser is displayed in the display frame 214. With this processing, even if an access operation is performed for the link 211a, it is possible to confirm the original and new Web browsers in the two display frames 213 and 214 without setting the original Web browser in a non-display state, thereby improving the user friendliness of the application.

At this time, as shown in FIG. 2A, the original and new applications may be displayed in the display frames having exactly the same size. The present invention, however, is not limited to this. As shown in FIG. 2B, the relative relationship between the attribute of the original application and that of the new application is determined, and then the size ratio between the display frames may be changed in accordance with a determination result.

At this time, as shown in FIG. 2C, new application D may be displayed in place of already displayed application C. Furthermore, as shown in FIG. 2D, after generating the display frame 214 in which new application B is displayed, and transiting to the second screen mode 202, the mode may automatically return to the first screen mode 201 under a predetermined condition such as a lapse of a predetermined time.

In addition, as shown in FIG. 2E, in a state in which three display frames 251 to 253 are displayed, if application B is executed by a tap operation for the link of application A in the display frame 251, the display frames 252 and 253 may be set in the non-display state. After the display frames 252 and 253 are set in the non-display state, the execution screen of application B is displayed in a new display frame 255. At this time, the user may be inquired of whether to erase the display frame. An inquiry may be made to the user by displaying a selection screen for selecting a display frame to be erased and a display frame not to be erased.

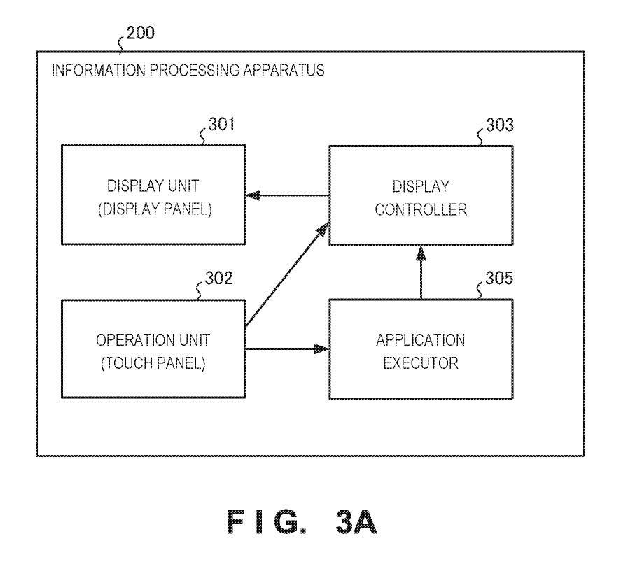

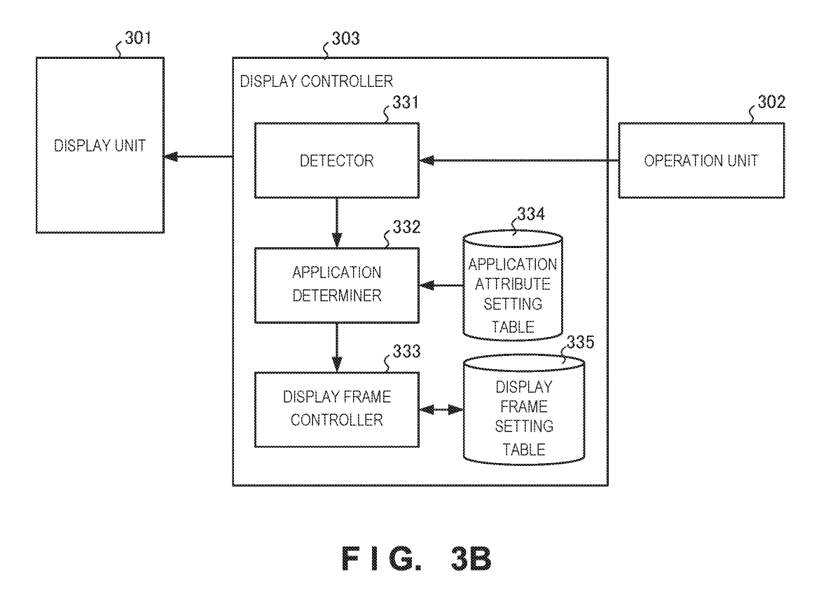

FIG. 3A is a block diagram showing the functional arrangement of the information processing apparatus 200. The information processing apparatus 200 includes a display panel as a display unit 301, a touch panel as an operation unit 302, a display controller 303, and an application executor 305.

The application executor 305 executes an application in response to a user operation on the operation unit 302. An application execution result is sent to the display controller 303.

The display controller 303 generates a display image in accordance with the application execution result. At this time, in accordance with settings (the upper limit of the display frame count and the like) input from the operation unit 302, the display controller 302 generates at least one display frame, and displays it so that it is possible to discriminate an active display frame from an inactive display frame.

For example, if the upper limit of the display frame count is set to one, the display controller 303 always performs full-screen display. If the upper limit of the display frame count is set to two, when one application is executed, full-screen display is performed. However, in a state in which two or more applications are executed, the execution results of two applications are arranged and displayed in two display frames. This allows the user to see the execution results of the plurality of applications at the same time. The display frame count may be settable to three or more, as a matter of course. Furthermore, the arrangement of the respective display frames may be freely settable. Alternatively, when the display frame count is determined, the positions of the respective display frames may be automatically determined.

A functional arrangement in which the number of display frames to be simultaneously displayed can be selected every time may be adopted. For example, in a state in which four applications are executed, one of the applications may be selected and undergo full-screen display or two of the applications may be selected and undergo 2-division display (the display frame count is two).

Under the control of the display controller 303, the display unit 301 arranges the display frames 211 and 212 side by side on the screen 210, and displays, in the display frames 211 and 212, pieces of information generated by the different applications.

FIG. 3B is a block diagram showing the internal arrangement of the display controller 303. The display controller 303 includes a detector 331, an application determiner 332, a display frame controller 333, a application attribute setting table 334, and a display frame setting table 335.

Based on an input from the operation unit 302, the detector 331 detects that another application is called from an already executed and displayed application. Especially, the detector 331 detects that the second application is called when the link displayed in the first display frame is selected while the information generated by the application is displayed in the first screen mode.

With reference to the application attribute setting table 334, the application determiner 332 determines, for the application to be newly executed, the relative relationship with the currently executed application. More specifically, the relative relationship is determined in accordance with the category of the application. Based on the attributes of the pieces of information generated by the applications, the application determiner 332 may determine the relative relationship between the attributes of the plurality of applications simultaneously displayed. For example, depending on whether the information generated by each application includes an image, moving image, or document input field, the application determiner 332 may determine the relative relationship between the attributes of the plurality of applications simultaneously displayed.

A determination result is sent to the display frame controller 333. When increasing display frames using the display frame setting table 335, the display frame controller 333 sets, for the plurality of display frames, sizes corresponding to the relative relationship between the attributes of the corresponding applications. For example, since a music playback application has a low priority level, information generated by the music playback application is displayed in a display frame having a size smaller than that of a display frame for information generated by another application.

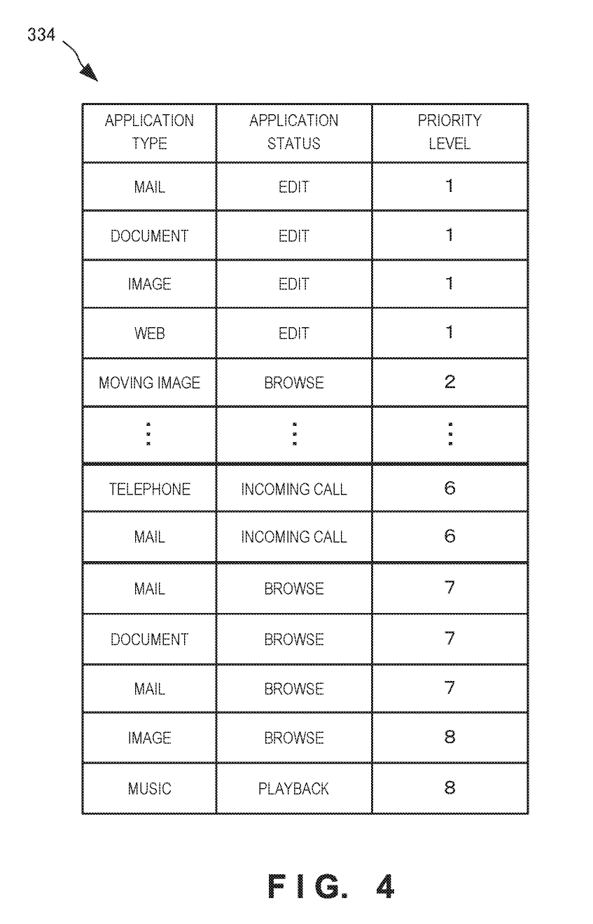

The application attribute setting table 334 sets a relative priority level for each attribute or status of each application. The application attribute setting table 334 has, for example, a structure shown in FIG. 4, in which priority levels are assigned to various statuses for each application type. The application determiner 332 determines the relative relationship between applications to be simultaneously displayed. If, for example, applications with priority levels 1 and 8 are displayed, the size ratio between display frames is 8:1. These numerical values are merely examples, as a matter of course, and the present invention is not limited to them.

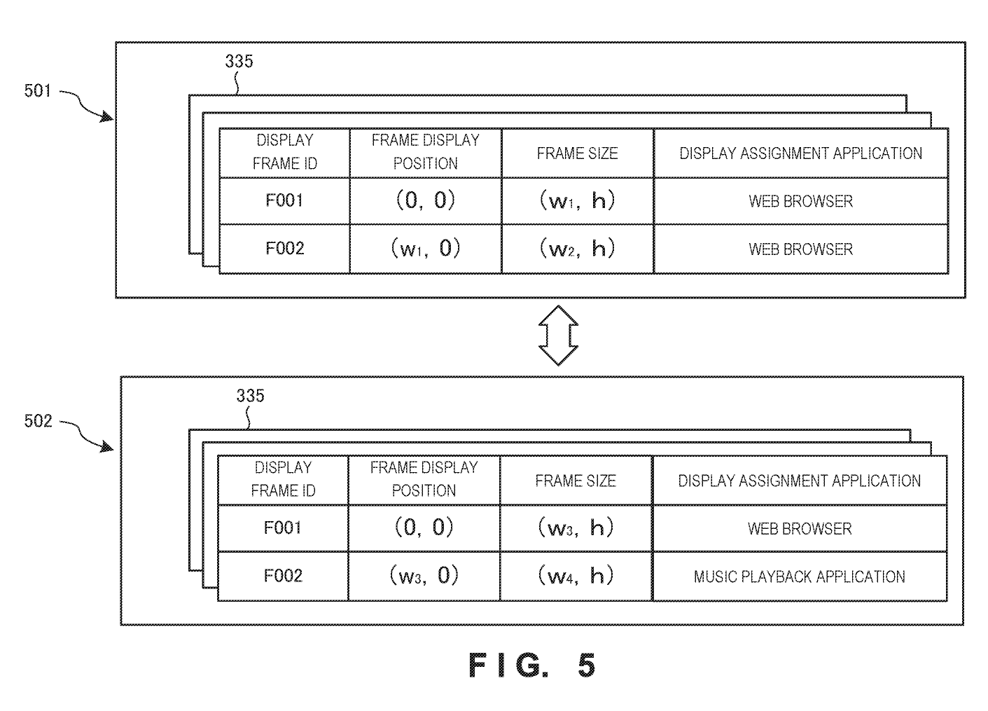

The display frame setting table 335 has, for example, a structure shown in FIG. 5. The display frame setting table 335 shown in FIG. 5 is prepared for each display frame count, in which a display frame ID, a frame display position, a frame size, and a display assignment application are set. That is, in a state 501 on the upper side of FIG. 5, a display frame with an ID “F001” is displayed at a position of coordinates (0, 0) in a size (width, height)=(w1, h), and a display frame with an ID “F002” is displayed at a position of coordinates (w1, 0) in a size (width, height)=(W2, h). Different Web browser applications are respectively assigned to the display frames F001 and F002.

On the other hand, if the Web browser and the music playback application are respectively assigned to the displays frames F001 and F002, the frame size of the frame F001 is changed to a size (w3, h) (w3>w1), and the frame position and size of the frame F002 are changed to a position (w3, 0) and a size (w4, h). These changes implement the change of the display shown in FIGS. 2A and 2B.

As shown in FIG. 2C, if an application as a display target for a display frame is replaced, contents of a display assignment application in the display frame setting table 335 are replaced. Furthermore, if, as shown in FIG. 2D, after generating the display frame 214 in which new application B is displayed, and transiting to the second screen mode 202, the mode automatically returns to the first screen mode 201 under the predetermined condition such as a lapse of a predetermined time, the display frame settings are changed from a table of two display frames to a table of one display frame.

In addition, as shown in FIG. 2E, in the state in which the three display frames 251 to 253 are displayed, if application B is executed by a tap operation for the link of application A in the display frame 251, the display frames 252 and 253 may be set in the non-display state.

The display settings are changed from a table of three rows of the three display frame IDs F001 to F003 to the table of two rows shown in FIG. 5.

The display frame controller 333 automatically transits to the second screen mode, and arranges the second and third display frames on the screen. In addition to the table shown in FIG. 5, the display frame setting table 335 stores a setting value for setting whether to display the information generated by the second application in the first display frame in the first screen mode when the second application is called from the first application while the information generated by the first application is displayed in the first screen mode. The display frame setting table 335 also stores a setting value for setting whether to automatically transit to the second screen mode and arrange the second and third display frames on the screen when the second application is called from the first application while the information generated by the first application is displayed in the first screen mode.

With reference to the display frame setting table 335, the display frame controller 333 determines whether to display the information generated by the second application in the first display frame in the first screen mode when the second application is called from the first application while the information generated by the first application is displayed in the first screen mode. In accordance with the attributes of the first and second applications, the display frame controller 333 determines whether to automatically transit to the second screen mode and arrange the second and third display frames on the screen.

If the second application is called from the first application while the information generated by the first application is displayed in the first screen mode, the display frame controller 333 may temporarily transit to the second screen mode and arrange the second and third display frames on the screen. After that, under the predetermined condition, the display frame controller 333 may return to the original first screen mode. An example of the predetermined condition is a lapse of a predetermined time.

<<Hardware Arrangement of Information Processing Apparatus>>

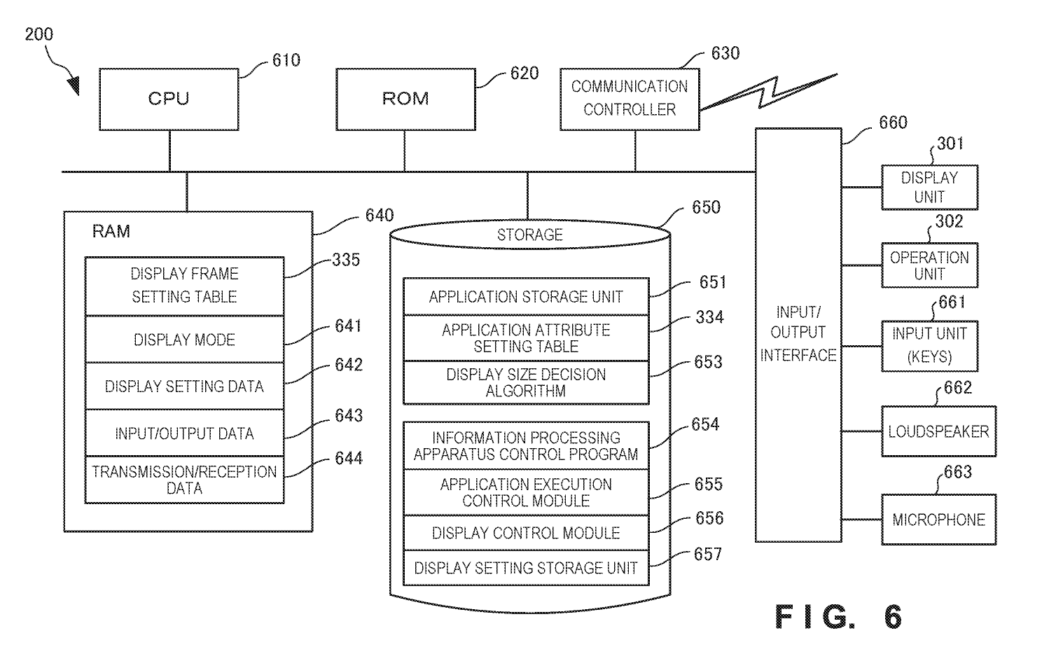

FIG. 6 is a block diagram showing the hardware arrangement of the information processing apparatus 200 according to this embodiment.

Referring to FIG. 6, a CPU (Central Processing Unit) 610 is an arithmetic control processor, and implements the functional components of the information processing apparatus 200 shown in FIG. 3A by executing a program. A ROM (Read Only Memory) 620 stores permanent data such as initial data and a program, and programs. A communication controller 630 communicates with another apparatus via a network. Note that the number of CPUs 610 is not limited to one, and a plurality of CPUs or a GPU (Graphic Processing Unit) for image processing may be included. The communication controller 630 desirably includes a CPU independent of the CPU 610, and writes or reads out transmission/reception data in or from the area of a RAM (Random Access Memory) 640. It is desirable to provide a DMAC (Direct Memory Access Controller) (not shown) for transferring data between the RAM 640 and a storage 650. Furthermore, an input/output interface 660 desirably includes a CPU independent of the CPU 610, and writes or reads out input/output data in or from the area of the RAM 640. Therefore, the CPU 610 processes the data by recognizing that the data has been received by or transferred to the RAM 640. Furthermore, the CPU 610 prepares the processing results of various applications in the RAM 640, and delegates succeeding transmission or transfer to the communication controller 630, DMAC, or input/output interface 660.

The RAM 640 is a random access memory used as a temporary storage work area by the CPU 610. An area to store data necessary for implementation of the embodiment is allocated to the RAM 640. As an example, the display frame setting table 335, a display mode 641, display setting data 642, input/output data 643, and transmission/reception data 644 are temporarily stored in the RAM 640. The input/output data 643 are transfer data exchanged with the display unit 301 and the operation unit 302 via the input/output interface 660. The transmission/reception data 644 are data transmitted/received via the communication controller 630.

The storage 650 stores a database, various parameters, or the following data or programs necessary for implementation of the embodiment. An application storage unit 651 stores applications executable by the information processing apparatus 200. A display size decision algorithm 653 is a program for deciding a display size.

The storage 650 further stores the following programs. An information processing apparatus control program 654 is a basic program for controlling the overall information processing apparatus 200. An application execution control module 655 is a module for executing applications stored in the application storage unit 651. A display control module 656 is a module for performing display control according to the display frame setting table 335. More specifically, the display control module 656 controls the arrangement, on the display unit 301, of the display frames assigned with pieces of display information generated by executing the applications. A display setting storage unit 657 stores various display settings.

The input/output interface 660 interfaces input/output data with an input/output device. The input/output interface 660 is connected to the display unit 301, the operation unit 302, an input unit 661 with hardware keys, a loudspeaker 662, a microphone 663, and the like. Although not shown, the input/output interface 660 is connected to a GPS (Global Positioning System) position determiner, an acceleration sensor, a geomagnetic sensor, and the like.

<<Processing Procedure of Information Processing Apparatus>>

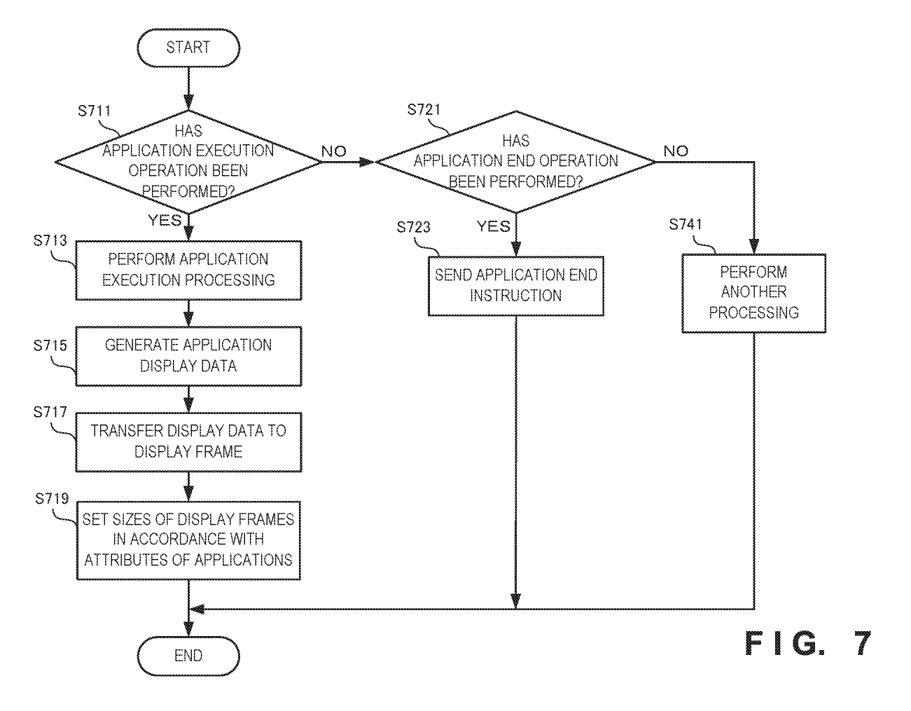

FIG. 7 is a flowchart illustrating the processing procedure of the information processing apparatus 200 according to this embodiment. The respective processes of this flowchart are executed by the CPU 610 of FIG. 6 using the RAM 640, thereby implementing the functional components shown in FIG. 3A.

In step S711, the information processing apparatus 200 determines whether an application execution operation has been performed on a display screen. If an application execution operation has been performed, the information processing apparatus 200 executes an instructed application in step S713. In step S715, the information processing apparatus 200 generates display data related to execution of the application. In step S717, the information processing apparatus 200 transfers the generated display data to display it in an assigned display frame. The process advances to step S719, and the information processing apparatus 200 sets the sizes of display frames in accordance with the attributes of respective applications to be displayed, and simultaneously displays the plurality of applications in at least two display frames.

If no application execution operation has been performed, the information processing apparatus 200 determines in step S721 whether an operation of ending the currently executed application has been performed. If the operation of ending the currently executed application has been performed, the information processing apparatus 200 ends the instructed application in step S723.

If neither an application execution operation nor an application end operation has been performed, the information processing apparatus 200 performs, in step S741, another processing instructed and operated.

As described above, according to this embodiment, it is possible to provide a user-friendly information processing apparatus which can display information of a new application without hiding information of an original application since a mode is automatically changed to a multi-display frame mode in response to an execution instruction of the new application.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188306 filed on Sep. 16, 2014, which is hereby incorporated by reference herein in its entirety.

1. An information processing apparatus comprising:
a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame; and
a display controller that automatically transits to the second screen mode, arranges the second display frame and the third display frame on the screen, and displays the information generated by the first application and the information generated by the second application, if the second application is called from the first application while the information generated by the first application is displayed in the first screen mode.

2. The information processing apparatus according to claim 1, wherein when the second application is called by selecting a link displayed in the first display frame while the information generated by the first application is displayed in the first screen mode, said display controller automatically transits to the second screen mode and arranges the second display frame and the third display frame on the screen.

3. The information processing apparatus according to claim 1, wherein if the second application is called from the first application while the information generated by the first application is displayed in the first screen mode,
whether to display the information generated by the second application in the first display frame in the first screen mode or automatically transit to the second screen mode and arrange the second display frame and the third display frame on the screen is selectable.

4. The information processing apparatus according to claim 1, wherein if the second application is called from the first application while the information generated by the first application is displayed in the first screen mode,
whether to display the information generated by the second application in the first display frame in the first screen mode or automatically transit to the second screen mode and arrange the second display frame and the third display frame on the screen is settable in advance.

5. The information processing apparatus according to claim 1, further comprising:
a determiner that determines, if the second application is called from the first application while the information generated by the first application is displayed in the first screen mode, whether to display the information generated by the second application in the first display frame in the first screen mode or automatically transit to the second screen mode and arrange the second display frame and the third display frame on the screen, in accordance with attributes of the first application and the second application.

6. The information processing apparatus according to claim 1, wherein if the second application is called from the first application while the information generated by the first application is displayed in the first screen mode,
a mode temporarily transits to the second screen mode to arrange the second display frame and the third display frame on the screen, and returns to the original first screen mode under a predetermined condition.

7. A control method of an information processing apparatus including a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame, the method comprising:
automatically transiting to the second screen mode and arranging the second display frame and the third display frame on the screen, if the second application is called from the first application while the information generated by the first application is displayed in the first screen mode.

8. A non-transitory computer readable medium storing a control program of an information processing apparatus including a display unit that can perform display in at least one of a first screen mode in which a first display frame is arranged on a screen and information generated by a first application is displayed in the first display frame and a second screen mode in which a second display frame and a third display frame are arranged on the screen, the information generated by the first application is displayed in the second display frame, and information generated by a second application is displayed in the third display frame, for causing a computer to execute a method, comprising:
automatically transiting to the second screen mode and arranging the second display frame and the third display frame on the screen, if the second application is called from the first application while the information generated by the first application is displayed in the first screen mode.
